(19) United States
(12) Patent Application Publication
(10) Pub. No.: US 2006/0141961 A1
(43) Pub. Date: Jun. 29, 2006

(54) Method and system for selective receiver shutdown

(76) Inventors: Philip A. Schentrup, Hollywood, FL (US); Jean Khawand, Miami, FL (US); Chin P. Wong, Parkland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/021,339

(22) Filed: Dec. 23, 2004

(51) Int. Cl. H04Q 7/20

(52) U.S. Cl. 455/133; 340/7.52

(57) ABSTRACT

The invention concerns a method (400) and system (100) for selective receiver shutdown. The method can include the steps of—at a mobile communications unit (128)—receiving (412) and transmitting (412) over a traffic channel (500) that supports the transmission of at least voice signals and has a receive channel (514) and a transmit channel (516) and selectively deactivating (416) a receiver (312) of the mobile communications unit to ignore an assigned portion (524) of the receive channel of the traffic channel. The assigned portion of the receive channel can be a payload portion (524), and the method can also include the step of selectively activating (414) the receiver to receive a control information portion (522) of the receive channel.

### BACKGROUND OF THE INVENTION

1. Field of the Invention

This invention relates in general to receivers for mobile communications units and more particularly to methods for selectively shutting down such receivers.

2. Description of the Related Art

In today's marketplace, consumers have numerous portable electronic devices, such as cellular telephones and personal digital assistants, from which to choose. These devices are packed with features that drain significant amounts of current from the batteries that are required to power them. In particular, virtually all mobile communications units have both a transmitter and a receiver, the operation of which may severely tax battery life. In response, the companies that produce portable electronic devices are constantly seeking ways to conserve energy while these devices are in operation.

### SUMMARY OF THE INVENTION

The present invention concerns a method for selective receiver shutdown. The method can include the step of—at a mobile communications unit—receiving and transmitting over a traffic channel that supports the transmission of at least voice signals. The traffic channel can have a receive channel and a transmit channel. The method can also include the step of selectively deactivating a receiver of the mobile communications unit to ignore an assigned portion of the receive channel of the traffic channel. As an example, the assigned portion of the receive channel that is ignored can be a payload portion. The method can also include the step of selectively activating the receiver to receive a control information portion of the receive channel. The method can further include the step of performing the selectively deactivating step when the mobile communications unit is in a transmit mode.

As an example, the control information portion of the receive channel can include at least one of a synchronization block, a slot descriptor block, a network element identifier block and an associated control procedure block. In one arrangement, the payload portion and the control information portion can be part of a receive slot that the mobile communications unit can receive over the received channel.

In another arrangement, the method can further include the steps of determining whether the control information portion includes an associated control procedure block and if no associated control procedure block exists in the control information portion, selectively deactivating the receiver to ignore a number of subsequent receive slots. The method can also include the steps of determining a signal strength of a network component and based on the signal strength determination, selectively deactivating the receiver to ignore the number of subsequent receive slots.

In yet another arrangement, the method can include the steps of determining whether the payload portion includes data relating to comfort noise and if the payload portion includes data relating to comfort noise, deactivating the receiver to ignore at least the payload portion. The method can further include the steps of determining a signal strength of a network component and based on the signal strength determination, deactivating the receiver to ignore at least the payload portion and a part of the synchronization block. As an example, the mobile communication unit can support at least one of interconnect service and dispatch service.

The present invention also concerns a mobile communications unit for selective receiver shutdown. The mobile communications unit can include a receiver, a transmitter and a processor coupled to the receiver and the transmitter. The receiver can receive over a traffic channel, and the transmitter can transmit over the traffic channel in which the traffic channel has a receive channel and a transmit channel. In one arrangement, the processor can be programmed to selectively deactivate the receiver to ignore an assigned portion of the receive channel of the traffic channel. The system can also include suitable software and circuitry for performing the processes described above.

The present invention also concerns a machine readable storage having stored thereon a computer program having a plurality of code sections executable by a mobile communications unit. The code sections can cause the mobile communications unit to receive and transmit over a traffic channel that supports the transmission of at least voice signals and has a receive channel and a transmit channel. The code sections can further cause the mobile communications unit to selectively deactivate a receiver of the mobile communications unit to ignore an assigned portion of the receive channel of the traffic channel. The code sections can also cause the mobile communications unit to perform or execute the steps described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a telecommunications system in accordance with an embodiment of the inventive arrangements;

FIG. 2 illustrates in more detail the telecommunications system of FIG. 1 in accordance with an embodiment of the inventive arrangements;

FIG. 3 illustrates an example of a mobile communications unit in accordance with an embodiment of the inventive arrangements;

FIG. 4 illustrates a portion of a method for selective receiver shutdown in accordance with an embodiment of the inventive arrangements;

FIG. 5 illustrates an example of a traffic channel in accordance with an embodiment of the inventive arrangements;

FIG. 6 illustrates an example of a receive slot in accordance with an embodiment of the inventive arrangements; and

FIG. 7 illustrates another portion of the method of FIG. 4 for selective receiver shutdown in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a method and system for selectively shutting down a receiver. In one arrangement, the method can include the step of—at a mobile communications unit—receiving and transmitting over a traffic channel that supports the transmission of at least voice signals. The traffic channel can have a receive channel and a transmit channel. The method can also include the step of selectively deactivating a receiver of the mobile communications unit to ignore an assigned portion of the receive channel of the traffic channel. In another arrangement, the portion of the receive channel that is ignored is the payload portion, and the method can further include the step of selectively activating the receiver to receive a control information portion of the receive channel. Through this selective activation and deactivation of the receiver in relation to the traffic channel, the life of the battery powering the mobile communications unit can be extended.

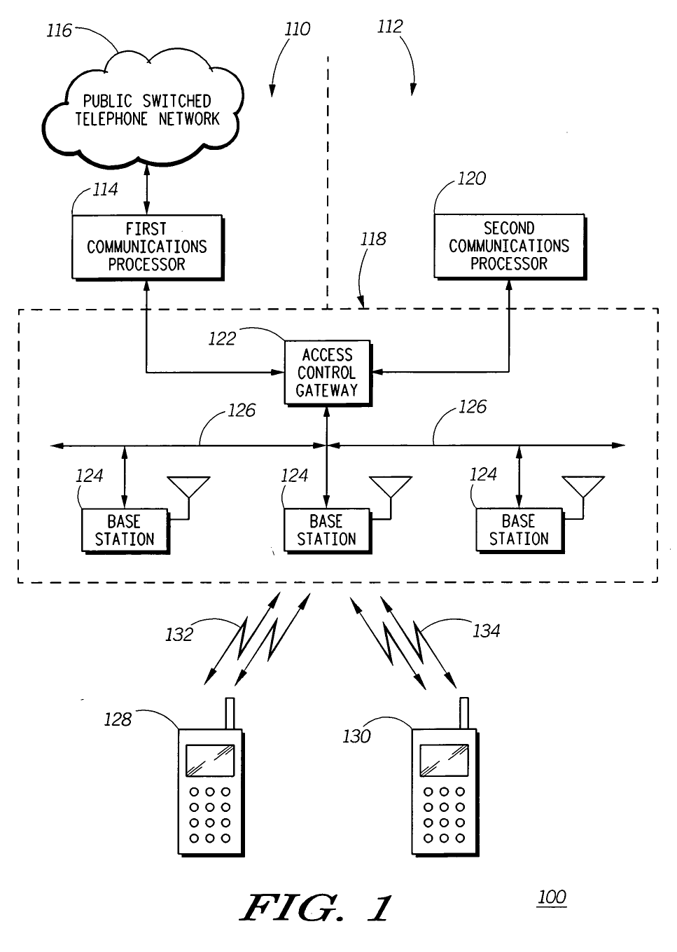

Referring to FIG. 1, a telecommunications system 100 is shown. As an example and without limitation, the system 100 can include both an interconnect telephone services portion 110 for supporting interconnect telephone services and a dispatch services portion 112 for supporting dispatch services. To support the interconnect services, the interconnect services portion 110 can include a first communications processor 114, which can be coupled to the public switched telephone network (PSTN) 116 and at least one site 118. The site 118 can include infrastructure that supports wireless communications.

To support the dispatch services, the dispatch services portion 112 can include a second communications processor 120, which can also be coupled to the site 118. As such, both the first communications processor 114 and the second communications processor 120 can share the infrastructure of the site 118 for processing both the interconnect and dispatch services. Although such a shared configuration is efficient, it is not necessary for the operation of either of these services. In addition, it is understood that the interconnect services portion 110 and the dispatch services portion 112 can be coupled to sites other than or in addition to site 118.

In one arrangement, the site 118 can include one or more access control gateways 122, one or more base stations 124 and one or more buses 126 for coupling the base stations 124 to the access control gateway 122. The base stations 124 can communicate with, for example, a first mobile communications unit 128 over a wireless communications link 132 and with, as another example, a second mobile communications unit 130 over another wireless communications link 134. Continuing with the example, a first user may operate the first mobile communications unit 128, and a second user may operate the second mobile communications unit 130.

Of course, the invention is not limited to this particular example, as either of the first mobile communications unit 128 or the second mobile communications unit 130, depending on their location, may be serviced by another site. The first mobile communications unit 128 and the second mobile communications unit 130 may support either interconnect service, dispatch service or both. Moreover, the first mobile communications unit 128 and the second mobile communications unit 130 can communicate with one another without the assistance of a communications network. In addition, any number of mobile communications units can take part in any communications envisioned by the inventive arrangements. As an example, a dispatch call may include three or more callers using mobile communications units receiving communications from the dispatch services portion 112.

The access control gateway 122 can include a computational platform having computational capacity and storage sufficient to support the functions described below. In addition, the link between the access control gateway 122 and the first communications processor 114 can be any high-level data link, as defined by the International Standards Organization. In one arrangement, the link between the access control gateway 122 and the second communications processor 120 can be a frame relay link. It is understood, however, that the invention is not limited in this regard, as any other suitable link can be used between the access control gateway 122 and the first communications processor 114 and second communications processor 120.

The base stations 124 can include radio transceivers configured to receive and transmit on appropriate frequencies using suitable modulation and air interface protocols for supporting the requirements of the services being provided. In another arrangement, the bus 126 that couples the base stations 124 to the access control gateway 122 can be an Ethernet link, as well understood in the art.

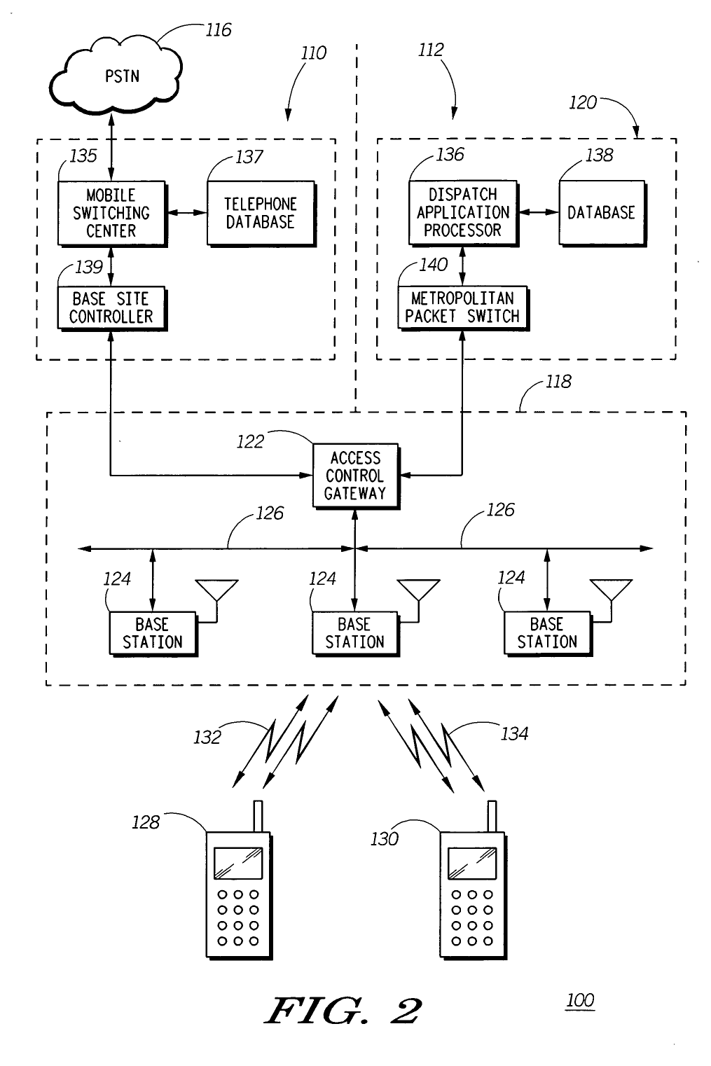

Referring to FIG. 2, the first communications processor 114 can include a mobile switching center 135, a telephone database 137 and a base site controller 139. As appreciated by those of skill in the art, the mobile switching center 135 can interface with the PSTN 116 and the base site controller 139. The mobile switching center 135 can also control the provision of interconnect service to, for example, the first mobile communications unit 128 and the second mobile communications unit 130, if the first mobile communications unit 128 and the second mobile communications unit 130 support such a service. The telephone database 137 can be coupled to the mobile switching center 135 and can provide to the mobile switching center 135 information concerning the operation of communications units, such as the first mobile communications unit 128 and the second mobile communications unit 130. As an example, this information can be present site location, present telephone call activity, billing information and roaming status.

The second communications processor 120 can include an application processor such as a dispatch application processor 136, a database 138 coupled to the dispatch application processor 136 and a metropolitan packet switch 140, which can also be coupled to the dispatch application processor 136. Further, dispatch application processor 136 can be coupled to the access control gateway 122 through the metropolitan packet switch 140. In one arrangement, the dispatch application processor 136 can be programmed to allocate communication resources among dispatch service users and can alert any members in a group of callers that a dispatch call is imminently or presently underway to enable those members of the group to participate in the call.

As those of ordinary skill in the art will appreciate, the metropolitan packet switch 140 can route audio signals between sites to facilitate the inclusion of callers that are located in other sites that the dispatch services portion 112 serves. The database 138 can include information that relates to the operability status of, for example, the first mobile communications unit 128 and the second mobile communications unit 130, although the database 138 can include information relating to the operability status of any suitable number of mobile communications units. As an example and without limitation, the information stored by the database 138 can include individual identification, group identification, alias information, roaming status and priority information.

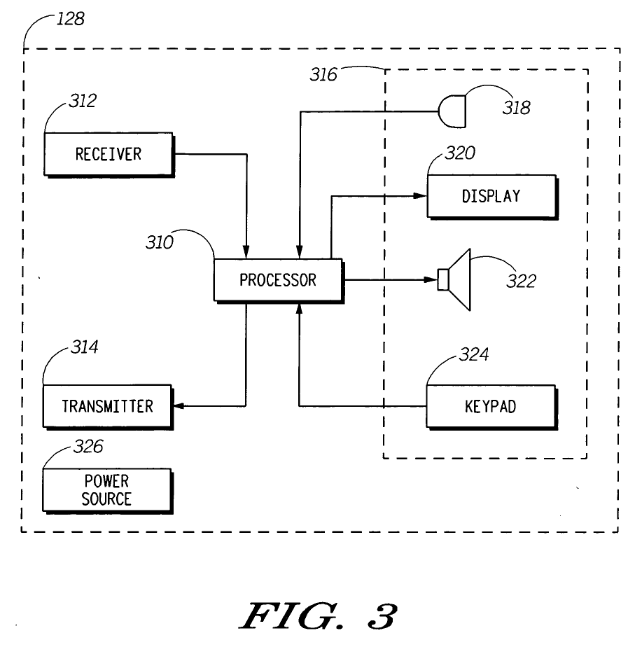

Referring to FIG. 3, an example of a mobile communications unit, such as the first mobile communications unit 128, is shown. The second mobile communications unit 130 can have a similar configuration. In this example, the first mobile communications unit 128 can have a processor 310, a receiver 312, a transmitter 314 and a user interface section 316. The processor 310 can be coupled to the receiver 312, the transmitter 314 and the user interface section 316. In one arrangement, the user interface section 316 can include a microphone 318, a display 320, a speaker 322 and a keypad 324. The first mobile communications unit 128 can also include a power source 326 for powering the processor 310, the receiver 312, the transmitter 314 and the user interface section 316. As an example, the power source 326 may be one or more rechargeable batteries.

As is known in the art, the receiver 312 can receive either interconnect or dispatch communications signals from the telecommunications system 100 of FIGS. 1 and 2. Additionally, the transmitter 314 can transmit interconnect or dispatch signals to the telecommunications system 100. As is also known in the art, the processor 310 can receive and process the signals from the receiver 312 and can forward them to the user interface section 316 to enable the signals to be converted to a form that is perceivable by a user. Similarly, the processor 310 can receive signals from the user interface section 316, process them and forward them to the transmitter 314 for transmission. Those of skill in the art will appreciate that the first mobile communications unit 128 may include one or more other components not described here to operate in accordance with well-known principles.

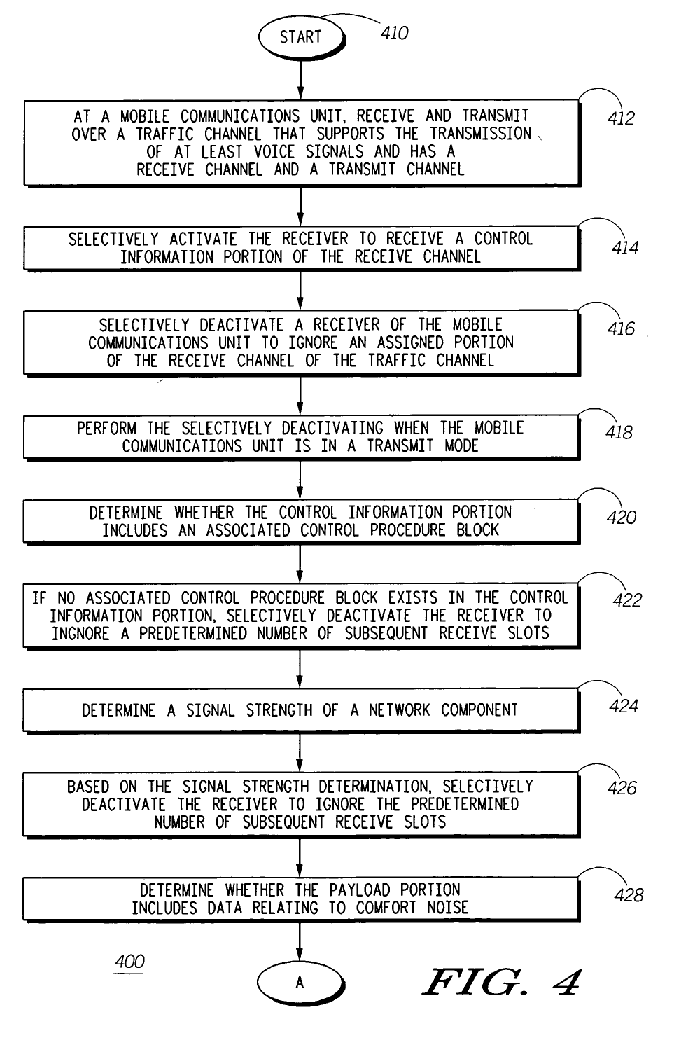

Referring to FIG. 4, a method 400 for selective receiver shutdown is shown. Reference will be made to FIGS. 2, 3, 5 and 6 when describing the steps of the method 400. It is understood, however, that the method 400 can be implemented into any other suitable telecommunications system or unit using any suitable transmission protocols. Moreover, the invention is not limited to the order in which the steps are listed in the method 400. In addition, the method 400 can contain a greater or a fewer number of steps than those shown.

At step 410, the method 400 can begin. At step 412, a mobile communications unit can receive and transmit over a traffic channel that supports the transmission of at least voice signals. The traffic channel can have a receive channel and a transmit channel. In addition, at step 414, a receiver of the mobile communications unit can be selectively activated to receive a control information portion of the receive channel. The receiver of the mobile communications unit can also be selectively deactivated to ignore an assigned portion of the receive channel of the traffic channel, as shown at step 416. At step 418, the selectively deactivating step may be performed when the mobile communications unit is in a transmit mode. For purposes of the invention, an assigned portion of the receive channel can be mean any portion of the receive channel that is intended to be received by the mobile communications unit.

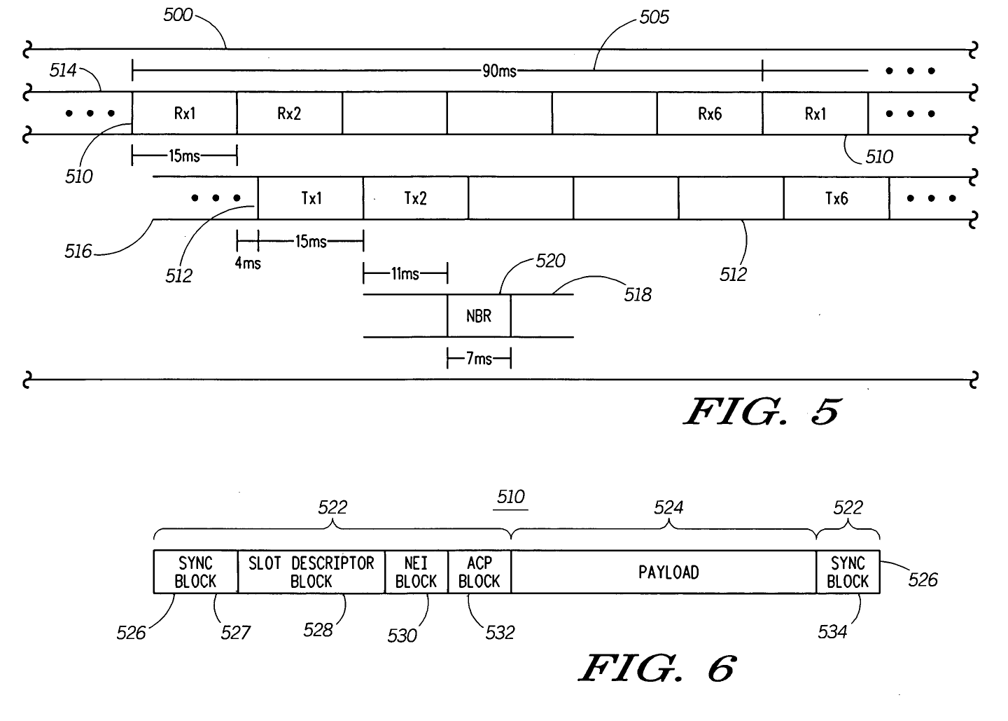

Referring to FIG. 5, an example of a traffic channel 500 that has a receive channel 514 and a transmit channel 516 is shown. Reference will also be made to FIGS. 2 and 3 to describe the elements of FIG. 5. In one arrangement, the traffic channel 500 can be a communications channel that can support the transmission of various types of signals, one of which being voice signals. As an example, the traffic channel 500 can also conform to a time division multiple access (TDMA) system, although the invention is not limited as such and contemplates other suitable transmission protocols.

In one particular arrangement, if the traffic channel 500 conforms to a TDMA system, the traffic channel 500 can be comprised of frames 505, each of which may be 90 milli-seconds (ms) in duration. In addition, the receive channel 514 can carry receive slots 510, and the transmit channel 516 can carry transmission slots 512. As is known in the art, only a portion of the receive slots 510 may be assigned to the mobile communications unit 128.

The receive slots 510 and the transmission slots 512 may be 15 ms in duration. In another arrangement, the receive slots 510 may include control information from, for example, the telecommunications system 100. The receive slots 510 may also contain voice and/or data being transmitted from a mobile communications unit through the base stations 124 of the telecommunications system 100, for example. The transmission slots 512 may carry control information and voice and/or data from the mobile communications unit 128 to be sent to the telecommunications system 100, for example, and on to one or more other mobile communications units.

As is known in the art, the receive channel 514 and the transmit channel 516 can be assigned different frequencies and can be offset by a predetermined amount of time. For example, from the start of a receive slot 510, such as the one designated as R_{X1}, to the start of a transmission slot 512, like the one designated with T_{X1}, a duration of 19 ms can exist. As such, a period of 4 ms can be present between the receive slots 510 and the transmission slots 512. As those of skill in the art can appreciate, this time period can permit the processor 310 of the mobile communications unit 128 to reconfigure the circuitry necessary to enable the transmitter 314 to transmit the transmission slots 512.

The traffic channel 500 can also include another channel 518 that can carry neighboring cell blocks 520. As is known in the art, the neighboring cell blocks 520 can contain information that relates to, for example, the signal strength of neighboring cells or other communications areas. The neighboring cell blocks 520 may also include information that helps the mobile communications unit 128 identify the neighboring cells. In one particular arrangement but without limitation, the neighboring cell blocks 520 can be 7 ms in duration and can be spaced 11 ms from the end of a transmission slot 512, such as the one labeled with T_{X1}.

To receive the receive channel 514, the processor 310 may activate the receiver 312. In accordance with an embodiment of the inventive arrangements, there may be instances where it is not necessary to receive at least portions of the receive channel 514. That is, the processor 310 can be programmed to deactivate or shut down the receiver 312 to ignore assigned portions of the receive channel 514. As an example, if the receive channel 514 is carrying receive slots 510, the processor 310 can shut down the receiver 312 to ignore at least a portion of one or more of the receive slots 510 assigned to the mobile communications unit 128.

Referring to FIG. 6, an example of a receive slot 510 is shown. In one arrangement, the receive slot 510 can have a control information portion 522 and a payload portion 524. The control information portion 522, for example, can include information from the telecommunications system 100 or some other suitable system or component that provides the mobile communications unit 128 with various control parameters and commands. The control information portion 522 may also include synchronization data, in addition to or in lieu of the control parameters and commands. The payload portion 524, also from the telecommunications system 100 or some other suitable system or component, can include the bits for voice or data carried over the traffic channel 500 that is meant to be displayed or broadcast to a user of the mobile communications unit 128.

As an example, the control information portion 522 can include a synchronizing block 526, a slot descriptor block 528, a network element identifier block 530 and an associated control procedure (ACP) block 532. The synchronizing block 526 may contain a first part 527 and a second part 534. The first part 527 of the synchronizing block 526 can provide data that enables the mobile communications unit 128 to synchronize with the telecommunications system 100 with respect to time and/or frequency. In one arrangement, if the signal quality from the base station 124 serving the mobile communications unit 128 is below a predetermined threshold, the second part 534 of the synchronizing block 526 can supplement this timing and frequency synchronization.

The slot descriptor block 528, as is known in the art, can provide information concerning, for example, the type of channel over which the receive slot 510 is being received and the identity of the mobile communications unit that is currently in a transmit mode. The network element identifier block 530 can provide data that identifies the network element, such as the base station 124, from which the receive channel 514 is received. Although not so limited, the network identifier block 530 may be referred to as a color code block.

The ACP block 532 can contain, for example, information about the identity of the mobile communications units that are involved in a group call with the mobile communications unit 128. For purposes of the invention, a group call can be a set of at least three mobile communications units involved in a call, including both a dispatch and an interconnect call. The ACP block 532 can also contain handover commands from the telecommunications system 100. The ACP block 532, as is known in the art, can steal bits from the payload portion 524. The term ACP block is used merely as an example, as any block that provides identity information or handover commands can be an ACP block.

There may be, however, certain circumstances where an ACP block 532 does not exist in the control information portion 522 for a particular receive slot 510 or for the entire receive channel 514. For example, the ACP block 532 may not be present in the receive channel 514 if the mobile communications unit 128 is involved in a private dispatch call with one or more separate mobile communications units. As another example, the ACP block 532 may be intermittently inserted in the receive channel 514, and only certain receive slots 510 may contain the ACP block 532. This scenario may be present in interconnect calls and some dispatch calls, for example.

In accordance with an embodiment of the inventive arrangements, the processor 310 can activate the receiver 312 to receive the control information portion 522 of the receive channel 514, such as that as contained in the receive slot 510. This process may or may not include the receipt of the second part 534 of the synchronization block 526, as will be explained below. The processor 310 can also deactivate the receiver 312 to ignore, for example, the payload portion 524 of the receive slot 510. This payload portion 524 can be an example of an assigned portion of the receive channel 514 that can be ignored. Because there may be circumstances where the mobile communications unit 128 is engaged in a call but is not currently receiving voice or data intended to be provided to the user of the unit 128, the payload portion 524 in the receive slot 510 may contain no relevant data. By deactivating the receiver 312 to ignore this part of the receive slot 510, the life of the power source 326 may be extended. The processor 310 can signal the receiver 312 to activate again to receive the control information portion 522 of the next receive slot 510 intended for the mobile communications unit 128. As will be seen below, however, portions of or entire subsequent receive slots 510, including their control information portions 522, may be ignored.

As noted earlier, the mobile communications unit 128 may engage in dispatch or interconnect calls. In a dispatch call, the selective deactivation of the receiver 312 can occur when the mobile communications unit 128 is in a transmit mode, for example. As is known in the art, when the mobile communications unit 128 is in a dispatch call, generally only one mobile communications unit will transmit over the traffic channel 500 at any given time. In this arrangement, the processor 310 of the transmitting mobile communications unit 128 can instruct the receiver 312 to deactivate to ignore the payload portion 524 of the receive slot 510, as described above.

For a dispatch call, the processor 310 can determine that the mobile communications unit 128 is in a transmit mode by, for example, sensing the activation of a push-to-talk (PTT) button or some other user interface component. The term transmit mode can mean any mode in which the mobile communications unit 128 is configured to transmit signals over the traffic channel 500, although the active transmission of voice is not necessarily required.

Referring back to the method 400 of FIG. 4, at step 420, it can be determined whether the control information portion includes an associated control procedure block. If no associated control procedure block exists in the control information portion, then the receiver can be selectively deactivated to ignore a predetermined number of subsequent receive slots, as shown at step 422. At step 424, a signal strength of a network component can be determined. At step 426, based on this signal strength determination, the receiver can be selectively deactivated to ignore a predetermined number of subsequent receive slots.

Referring once again to FIGS. 2, 3, 5 and 6, there may be instances where a number of entire receive slots 510 can be ignored, which means the receiver 312 does not have to read the control information portion 522 of all the receive slots 510 intended for the mobile communications unit 128. Although not limited, this process may be suitable when the mobile communications unit 128 is involved in a dispatch call.

For example, the processor 310 can determine whether an ACP block 532 exists in the control information portion 522 of the receive slots 510 on the receive channel 514. As an example, an ACP block 532 may not be present in the control information portion 522 of the receive slots 510 when the mobile communications unit 128 is involved in a dispatch call with one or more other callers. The processor 310 can obtain this status from any suitable portion of the receive channel 514, such as from the slot descriptor block 528 of an initial receive slot 510.

If, while the mobile communications unit 128 is in a transmit mode, the processor 310 determines that no ACP block 532 exists in the control information portion 522, the processor 310 can signal the receiver 312 to ignore a predetermined number of subsequent receive slots 510. The number of subsequent receive slots 510 can be any suitable value, and the value can be a predetermined value. Alternatively, the value may not be known beforehand. Such a scenario is possible where the receiver 312 can be deactivated to ignore all the receive slots 510 while the mobile communications unit 128 remains in a transmit mode, for example.

As an option, the process described immediately above can be performed when a signal strength of a network component is above a predetermined threshold. For purposes of the invention, signal strength can also include signal quality. For example, the processor 310 can determine the signal strength of a network component. Specifically, the network component can be the base station 124 in the telecommunications system 100 currently serving the mobile communications unit 128 or one or more neighboring base stations 124 that may possibly serve the mobile communications unit 128 in the near future.

If the signal strength of the network component, e.g., the base station(s) 124, is above a predetermined threshold, the processor 310 can deactivate the receiver 312 to ignore the number of subsequent receive slots 510. Because the ACP blocks 532 are not present and because the high signal quality may obviate the need for receiving the remaining elements of the control information portion 522 (such as the synchronization block 526), any suitable number of receive slots 510 can be ignored or skipped over during this process.

In one particular arrangement, the number of receive slots 510 that can be ignored can be correlated with the signal strength of the network component. As an example, as the signal strength increases, the number of receive slots 510 that can be ignored can increase. Additionally, if the signal strength drops below the predetermined threshold, the process of ignoring whole subsequent receive slots 510 can stop, if so desired. As another example, the process of selectively deactivating the receiver 312 to ignore the assigned portions of the receive channel 514 can stop when the mobile communications unit 128 leaves the transmit mode.

If ACP blocks 532 are present in the receive channel 514, it may not be desirable to ignore complete receive slots 510, as described above. Nonetheless, the processor 310 may instruct the receiver 312 to deactivate to ignore the second part 534 of the synchronization block 526 for the receive slots 510. This deactivation can be in addition to any deactivation directed towards ignoring the payload portion 524. As an option, the skipping of the second part 534 of the synchronization block 526 can be based on the signal strength of a network component, as described earlier. In other words, if the signal strength is above a predetermined threshold, it may not be necessary to receive the second part 534 of the synchronization block 526.

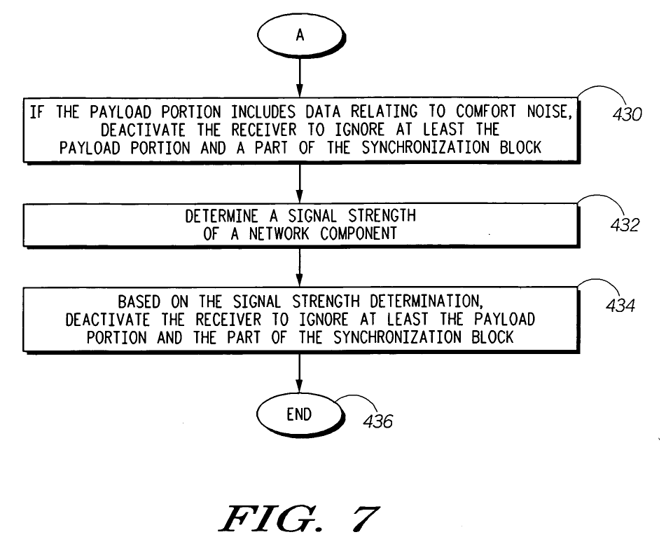

It is important to understand that this process is not limited to dispatch calls. Referring back to the method 400 of FIG. 4 and continuing to FIG. 7, the steps 428-434 give an example of a selective deactivation in an interconnect call. This process may occur when the mobile communications unit is in a transmit mode. In particular, at step 428, it can be determined whether the payload portion includes data relating to comfort noise. At step 430 of FIG. 7 (through jump circle A), if the payload portion includes data relating to comfort noise, the receiver can be deactivated to ignore at least the payload portion.

As an option, steps 428 and 430 can be based on a signal strength of a network component. As such, at step 432, a signal strength of a network component can be determined. Based on the signal strength determination, the receiver can be deactivated to ignore at least the payload portion and a part of the synchronization block, as shown at step 434. The method 400 can end at step 436.

For example, referring to FIGS. 2, 3, 5 and 6, the first mobile communications unit 128 may be engaged in an interconnect call with the second mobile communications unit 130. As those of skill in the art appreciate, the second mobile communications unit 130 may send comfort noise data over the receive channel 514 (through the telecommunications system 100) if the user of the second unit 130 is not currently speaking. The comfort noise data can be contained in the receive slots 510, for example. An indication that a particular receive slot 510 contains comfort noise data (i.e., no audio) can be implemented at or near the beginning of the payload portion 524. Alternatively, this indication can be implemented in the slot descriptor block 528. When the processor 310 detects this indication, the processor 310 can deactivate the receiver 312 to ignore at least the payload portion 524.

In another arrangement, the second part 534 of the synchronization block 526 may also be ignored. Like the deactivation process described above for dispatch, the deactivation procedure here can be based on a signal strength determination. In particular, the processor 310 can determine the signal strength or quality of a network component, such as a currently-serving base station 124 or one or more neighboring base stations 124. If this signal strength is above a predetermined threshold, then the processor 310 can deactivate the receiver 312 to ignore the second part 534 of the synchronization block 526.

As those of skill in the art will appreciate, ACP blocks 532 may be intermittently inserted in the receive channel 514 of an interconnect call. If so, it may not be desirable to skip whole receive slots 510, as the mobile communications unit 128 may need to search the receive slots 510 for the ACP blocks 532. If, however, the interconnect call does not contain ACP blocks 532, then any number of receive slots 510 can be ignored, similar to the process described earlier with respect to a dispatch call.

In either arrangement, the ignoring of the assigned portion of the receive channel 514 can stop when the processor 310 detects that the payload portion 524 no longer contains comfort noise data. As an example, the payload portion 524 may contain voice data. Also, if the signal strength drops below the predetermined threshold, the skipping of the second part 534 of the synchronization block 526 can stop, if so desired.

In another arrangement and as also explained earlier, another channel 518 of the traffic channel 500 can carry neighboring cell blocks 520 that can contain information that relates to the signal strength and identity of, for example, neighboring cells or other communications areas. In one arrangement, the processor 310 can activate the receiver 312 to receive the neighboring cell blocks 520. Once received, the processor 310 can once again deactivate the receiver 312. This second deactivation can last until the processor 310 determines that the receiver 312 needs to be activated again, which can be in accordance with the examples recited above.

In another arrangement, the processor 310 may instruct the receiver 312 to deactivate to ignore the neighboring cell block 520. In particular, the processor 310 can determine the signal strength of, for example, one or more of the base stations 124 in neighboring cells. For purposes of the invention, a neighboring cell can be any communication region that is not currently providing communication service to the mobile communications unit 128 but is within a predetermined range of the unit 128.

If the processor 310 determines that the signal strength is above a predetermined threshold, the processor 310 can keep the receiver 312 in the deactivated state. By having sufficient signal strength, it may not be necessary to receive the information embedded in the neighboring cell blocks 520 for any number of frames 505. If the signal strength drops below the predetermined threshold, the processor 310 can again activate the receiver 312 to receive the neighboring cell blocks 520.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product (including a machine readable storage having a plurality of code sections), which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for selective receiver shutdown, comprising:
at a mobile communications unit, receiving and transmitting over a traffic channel that supports the transmission of at least voice signals, the traffic channel having a receive channel and a transmit channel; and
selectively deactivating a receiver of the mobile communications unit to ignore an assigned portion of the receive channel of the traffic channel.

2. The method according to claim 1, wherein the assigned portion of the receive channel that is ignored is a payload portion and the method further comprises selectively activating the receiver to receive a control information portion of the receive channel.

3. The method according to claim 1, further comprising the step of performing the selectively deactivating step when the mobile communications unit is in a transmit mode.

4. The method according to claim 2, wherein the control information portion of the receive channel includes at least one of a synchronization block, a slot descriptor block, a network element identifier block and an associated control procedure block.

5. The method according to claim 4, wherein the payload portion and the control information portion are part of a receive slot that the mobile communications unit receives over the receive channel.

6. The method according to claim 5, further comprising:
determining whether the control information portion includes an associated control procedure block;
if no associated control procedure block exists in the control information portion, selectively deactivating the receiver to ignore a number of subsequent receive slots.

7. The method according to claim 6, further comprising:
determining a signal strength of a network component; and
based on the signal strength determination, selectively deactivating the receiver to ignore the number of subsequent receive slots.

8. The method according to claim 5, wherein the selectively deactivating step comprises:
determining whether the payload portion includes data relating to comfort noise; and
if the payload portion includes data relating to comfort noise, deactivating the receiver to ignore at least the payload portion.

9. The method according to claim 8, wherein the selectively deactivating step further comprises:
determining a signal strength of a network component; and
based on the signal strength determination, deactivating the receiver to ignore at least the payload portion and a part of the synchronization block.

10. The method according to claim 1, wherein the mobile communication unit supports at least one of interconnect service and dispatch service.

11. A mobile communications unit for selective receiver shutdown, comprising:
a receiver;
a transmitter, wherein the receiver receives over a traffic channel and the transmitter transmits over the traffic channel, wherein the traffic channel has a receive channel and a transmit channel and supports the transmission of at least voice signals; and
a processor coupled to the receiver and the transmitter, wherein the processor is programmed to selectively deactivate the receiver to ignore an assigned portion of the receive channel of the traffic channel.

12. The unit according to claim 11, wherein the assigned portion of the receive channel that is ignored is a payload portion and the processor is further programmed to selectively activate the receiver to receive a control information portion of the receive channel.

13. The unit according to claim 11, wherein the processor is further programmed to selectively deactivate the receiver when the mobile communications unit is in a transmit mode.

14. The unit according to claim 12, wherein the control information portion of the receive channel includes at least one of a synchronization block, a slot descriptor block, a network element identifier block and an associated control procedure block.

15. The unit according to claim 14, wherein the payload portion and the control information portion are part of a receive slot that the mobile communications unit receives over the receive channel.

16. The unit according to claim 15, wherein the processor is further programmed to:
determine whether the control information portion includes an associated control procedure block;
if no associated control procedure block exists in the control information portion, selectively deactivate the receiver to ignore a number of receive slots.

17. The unit according to claim 16, wherein the processor is further programmed to:
determine a signal strength of a network component; and
based on the signal strength determination, selectively deactivate the receiver to ignore the number of subsequent receive slots.

18. The unit according to claim 15, wherein the processor is further programmed to selectively deactivate the receiver by:
determining whether the payload portion includes data relating to comfort noise; and
if the payload portion includes data relating to comfort noise, deactivating the receiver to ignore at least the payload portion.

19. The unit according to claim 18, wherein the processor is further programmed to:
determine a signal strength of a network component; and
based on the signal strength determination, deactivate the receiver to ignore at least the payload portion and a part of the synchronization block.

20. The unit according to claim 11, wherein the mobile communications unit supports at least one of interconnect service and dispatch service.

21. A machine readable storage having stored thereon a computer program having a plurality of code sections executable by a mobile communications unit for causing the mobile communications unit to:
receive and transmit over a traffic channel that supports the transmission of at least voice signals, the traffic channel having a receive channel and a transmit channel; and
selectively deactivate a receiver of the mobile communications unit to ignore an assigned portion of the receive channel of the traffic channel.

22. The machine readable storage according to claim 21, wherein the assigned portion of the receive channel that is ignored is a payload portion and the code sections further cause the mobile communications unit to selectively activate the receiver to receive a control information portion of the receive channel.
